(19) United States
(12) Patent Application Publication
(10) Pub. No.: US 2012/0090318 A1
(43) Pub. Date: Apr. 19, 2012

(54) Supercharged Internal Combustion Engine

(76) Inventor: Jean Frederic Melchior, Paris (FR)

(21) Appl. No.: 13/254,303

(22) PCT Filed: Mar. 3, 2010
(86) PCT No.: PCT/FR10/00185

§ 371 Date: Nov. 18, 2011

(30) Foreign Application Priority Data
Mar. 3, 2009 (FR) 09 00956

(51) Int. Cl. F02B 33/44

(52) U.S. Cl. 60/598

(57) ABSTRACT

Reciprocating internal combustion engine supercharged by a turbocharger of which the compressor (10) is driven by a turbine rotor (7) supplied with burnt gases on the entire periphery thereof by a single distribution volute (6), this engine comprising two cylinder groups purged by two exhaust collectors (3) giving respectively into one of two convergent nozzles (4) parallel to the inlet direction of the volute (6) of the turbine and of which the collars (8) are adjacent and have cross-sections that are equal to that of the inlet (5) of the volute (6), the nozzles (4) being carried out at the volute by a convergent conical channel (9) of which the length is between 3 and 8 times the inlet diameter of the volute.

The invention relates to a reciprocating internal combustion engine that is surpercharged by a turbocharging unit.

Reciprocating internal combustion engines emit a highly pulsed flow of burnt gases generated by the successive purges of the cylinders. When the engine is supercharged by one or more turbochargers, it is advantageous to make use of the pressure pulses prevailing in the exhaust manifold in order to increase the expansion ratio of the turbines.

Nevertheless, the pressure pulses must not take place when a cylinder is being purged, otherwise burnt gases will be reintroduced therein and degrade the volumetric yield of the engine. In order to prevent these disadvantages, the cylinders are separated into groups wherein the exhaust phases do not interfere with each other. Each group is purged by an exhaust manifold connected to a turbine inlet. It is for this reason that four-stroke engines comprise groups of three cylinders at most. Six-cylinder engines include in general two groups of 3 cylinders and four-cylinder engines two groups of 2 cylinders.

In order to limit the number of turbines and increase the frequency of the pulses that supply each turbine, turbines have been developed with several gas inlets of which each one supplies a sector of the turbine rotor with a different pressure. This arrangement generates parasitic flows which degrade the yield of the turbine.

In order to prevent these disadvantages, four- or six-cylinder engines are frequently associated with so called “twin scroll” radial turbines of which the rotor is supplied across the entire circumference thereof by two adjacent twin volutes each connected to a group of cylinders via a convergent nozzle which accelerates the gases to the peripheral speed of the rotor. This arrangement has the disadvantage that the tangential speed of the gases at the inlet of the rotor varies greatly with the supply pressures of the two volutes.

In order to overcome these disadvantages, the invention proposes a reciprocating internal combustion engine supercharged by a turbocharger of which the compressor is driven by a turbine rotor supplied with burnt gases on the entire periphery thereof by a single distribution volute, this engine comprising two cylinder groups purged by two exhaust manifolds giving respectively into one of the two convergent nozzles parallel to the inlet direction of the turbine volute and of which the collars are adjacent and have cross-sections equal to that of the inlet of the volute, characterised in that the nozzles are connected to the volute by a convergent conical channel of which the length is between about 3 and 8 times the inlet diameter of the volute, this channel being tangential to the volute and being an extension, upstream, of the collars of the nozzles and, downstream, of the inlet cross-section of the volute.

In accordance with the invention, the two pulsed flows converge towards a single distribution volute similar to that of the turbines with a single gas inlet. This distribution volute, dimensioned for the rotor, has an inlet cross-section Sc (critical cross-section).

It is extended upstream by a straight channel which is tangential to it and which connects the inlet of the volute with cross-section Sc to the outlet of two adjacent convergent nozzles, with cross-section at the collar Sc and with axes substantially parallel to that of the channel. Each of these nozzles is supplied by an exhaust manifold of the engine. The cross-section of the convergent channel decreases therefore from a value 2Sc to a value Sc. The wall of the channel is a conical surface bearing on the one hand on the inlet of the volute and on the other hand on the outlet of the two nozzles. The length of this channel is sufficient so that the flow coming from each nozzle returns to the volute with a minimum deviation.

The advantage of this configuration is to generate a speed of the gases in the distribution volute which depends little on the differences in pressure in the two collectors.

In extreme conditions of supply:
when the two nozzles are supplied at the same pressure, the two flows are first accelerated separately to an intermediary speed in the twin nozzles then are joined together in the convergent channel for the final acceleration to the peripheral speed of the rotor;
when a single nozzle is supplied, with the other being sealed, the single flow is accelerated in its nozzle to the peripheral speed of the rotor in order to form a cross-section stream Sc which passes through the convergent channel at a constant speed wherein the static pressure is substantially constant in order to penetrate into the distribution volute;
when the two nozzles are supplied at different pressures, the two flows are adjusted in order to equal the static pressures at the collars of the two and the two resulting streams are accelerated by mixing together in the convergent channel in order to reach the peripheral speed of the rotor at the inlet of the distribution volute.

According to other characteristics of the invention:
the turbine is of the radial flow type,
the two nozzles have a planar adjacent wall that is perpendicular to the axis of rotation of the turbine,
the two nozzles have a planar adjacent wall that is parallel to the axis of rotation of the turbine,
the nozzles are of revolution and are coaxial to the circular conical channel which extends the exterior annular nozzle in order to return to the inlet of the volute,
the conicity of the straight channel extends that of the volute and of the collar of the nozzles.

The invention shall be better understood and other characteristics, details and advantages of the latter shall appear more clearly when reading the following description, provided by way of example in reference to the annexed drawings wherein:

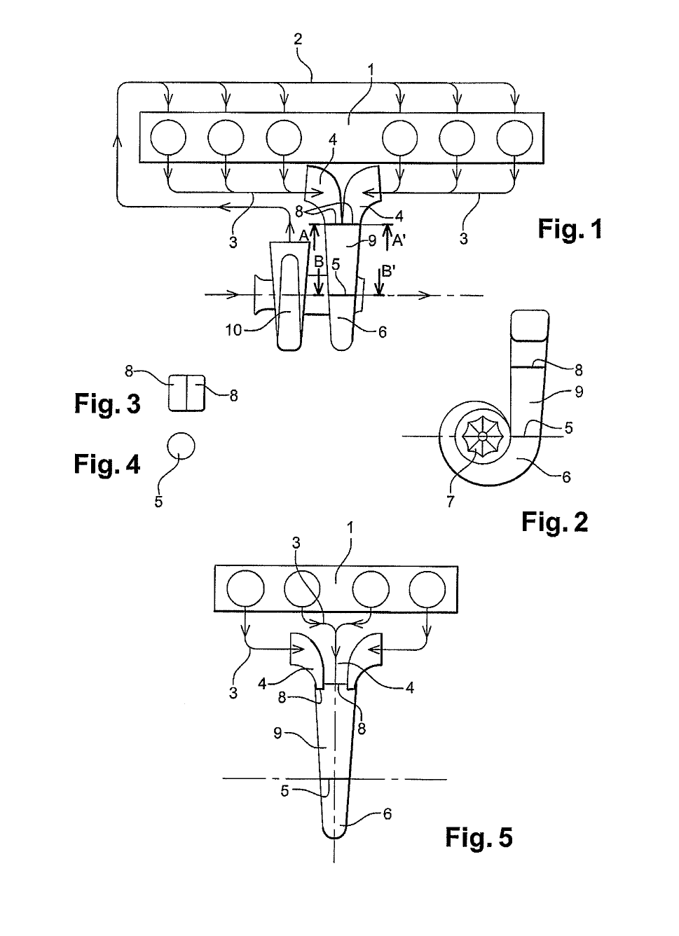

FIG. 1 is a schematic view of an embodiment of the invention with side-by-side nozzles, applied to an in-line 6-cylinder engine;

FIG. 2 is a view of the volute parallel to the axis of the turbine;

FIGS. 3 and 4 show two transversal cross-sections of the convergent channel according to lines A-A′ and B-B′ of FIG. 1;

FIG. 5 is a schematic view of an embodiment of the invention with coaxial nozzles, applied to an in-line 4-cylinder engine.

Reference is first made to FIGS. 1, 2 and 3 wherein the reference 1 designates a four-stroke reciprocating engine and with six in-line cylinders distributed into two groups of 3 cylinders as shown hereinabove, which comprises an intake manifold 2 that is common to the six cylinders and two exhaust manifolds 3 connected to the two cylinder groups. The intake manifold 2 is connected to the outlet of an air compressor 10 driven by a turbine 7 supplied with burnt gases by the two exhaust manifolds 3.

Each manifold 3 is connected by one of the two adjacent convergent nozzles 4 and by a convergent channel 9 to the inlet 5 of a distribution volute 6 supplying the rotor of the turbine 7 on the entire periphery thereof. The collar 8 of each nozzle 4 has a giving-into cross-section equal to the inlet cross-section 5 of the volute 6.

The convergent conical channel 9 extends the two nozzles 4 to the inlet 5 of the volute 6 tangentially to the latter. The substantially rectangular upstream cross-section and the substantially circular downstream cross-section of the channel 9 are shown in FIGS. 3 and 4. The length of the channel 9 must be sufficient for the stream exiting from one of the nozzles 4 can return to the inlet cross-section 5 of the volute 6 with a low deviation and that the streams of the two nozzles can be mixed together before penetrating into the volute. In practice, the length of the channel 9 is between about 3 and 8 times the diameter of the inlet cross-section 9 of the volute, according to the space available. A coaxial configuration of the nozzles 4 makes possible a channel length that is less than that of the side-by-side configuration.

Reference is now made to the FIG. 5 wherein the same references are used as previously and which shows another embodiment of the invention.

The engine 1 of FIG. 5 comprises four in-line cylinders distributed into one group of two central cylinders and one group of two end cylinders, connected respectively to two nozzles 4 of revolution coaxial to the inlet axis of the volute 6.

As previously, the collars 8 of the two nozzles 4 have a cross-section equal to the inlet cross-section 5 of the volute 6. The circular conical channel 9 extends the exterior nozzle 4 to reach the circular inlet 5 of the distribution volute 6 similar to that already described. The advantage of this configuration is a deviation that is almost zero of the streams of each nozzle and a substantial mixing surface between the streams.

The operation of the invention shall now be described in reference to FIGS. 1 to 5.

First recall that the purpose of the invention is to expand in the same turbine two flows generated by the purging of the cylinders of each one of the two groups, of which the total pressure varies periodically and which are in inversion of phase.

In order to simplify the statement, this shall be limited to a six-cylinder diesel engine equipped with valve elements in accordance with application WO 2008/090273, which generates in each manifold 3 a pressure pulse over 60 degrees of rotation of the drive shaft followed by a constant pressure over 180 degrees of rotation, the two manifolds being dephased by 120 degrees. In this engine, the turbine is supplied during 60 degrees of rotation by a pulse in a nozzle and by a constant pressure P in the other nozzle then for 60 degrees of rotation by the same constant pressure P in the two nozzles.

The situation at the crest of the pulse which is located at 2P, is as follows: the flow of gas in each nozzle will establish itself in order to balance the static pressure at the two collars. As the expansion ratio in the high pressure nozzle is critical, the static pressure at the collars is equal to the constant pressure P impose by the other nozzle which has no output. The turbine is then supplied exclusively by the high pressure nozzle with a total pressure 2P. The sonic stream emitted by the high pressure nozzle passes through the channel 9 wherein the static pressure is constant and equal to P in order to fill the volute 6.

When the two nozzles are supplied at the same constant pressure P, the flow in each nozzle, equal to half of the flow of the turbine, undergoes a first acceleration in the nozzle and then returns to the other flow in order to undergo a second acceleration in the channel 9 before penetrating in the volute 6.

The flow of the turbine in the first situation is controlled by the collar 8 while the flow of the turbine in the second situation is controlled by the cross-section 5 of the same surface. The ratio of the flows is substantially that of the generating pressures and is therefore equal to 2.

In intermediary situations wherein the pressure in a manifold 3 is equal to P and the pressure in the other manifold 3 is between P and 2P, the flow of each nozzle 4 is adjusted so that the static pressures at the two collars 8 is identical. Downstream of the collars 8, the two streams are mixed together by being accelerated in the convergent conical channel in order to supply the volute 6 with a total pressure between those of the two manifolds 3 and according to the ratio of the flows of the nozzles 4.

1. A reciprocating internal combustion engine supercharged by a turbocharger of which the compressor is driven by a turbine rotor supplied with burnt gases on the entire periphery thereof by a single distribution volute, this engine comprising two cylinder groups purged by two exhaust collectors giving respectively into one of two convergent nozzles parallel to the inlet direction of the volute of the turbine and of which the collars are adjacent and have cross-sections that are equal to that of the inlet of the volute, wherein the nozzles are carried out at the volute par a convergent conical channel of which the length is between 3 and 8 times the inlet diameter of the volute, the channel being tangential to the volute and being an extension, upstream, of the collars of the nozzles and, downstream, of the inlet cross-section of the volute.

2. The reciprocating engine according to claim 1, wherein the turbine is of the radial flow type.

3. The reciprocating engine according to claim 1, wherein the two nozzles have a planar adjacent wall that is perpendicular to the axis of rotation of the turbine.

4. The reciprocating engine according to claim 1, wherein the two nozzles have a planar adjacent wall that is parallel to the axis of rotation of the turbine.

5. The reciprocating engine according to claim 1, wherein the nozzles are of revolution and are coaxial to the conical channel which extends the exterior annular nozzle in order to return to the inlet of the volute.

6. The reciprocating engine according to claim 1, wherein the conicity of the straight channel extends that of the volute and of the collar of the nozzles.
